(19) United States
(12) Patent Application Publication
(10) Pub. No.: US 2008/0209946 A1
(43) Pub. Date: Sep. 4, 2008

(54) APPARATUS FOR MOLDING OPTICAL ELEMENT

(75) Inventor: Shinji TANAKA, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Chiyoda-ku (JP)

(21) Appl. No.: 12/043,389

(22) Filed: Mar. 6, 2008

Related U.S. Application Data
(63) Continuation of application No. PCT/JP2006/317577, filed on Sep. 5, 2006.

(30) Foreign Application Priority Data
Sep. 6, 2005 (JP) 2005-257843

(51) Int. Cl. C03B 11/00; C03B 11/16

(52) U.S. Cl. 65/244

(57) ABSTRACT

A molding apparatus for optical elements is provided, which reduces thermal influence receiving from adjacent production steps by a simple structure and simple process steps, and which can carry out molding of precision optical elements.

The apparatus comprises a conveying path 2 having a plurality of tables 6 continuously arranged to circulate a mold 15 constituted by a top mold, a bottom mold and a body mold, and the apparatus applies heating, press-molding and cooling steps to the mold 5 placed on the tables 6 during the circulation, wherein a gap of at least about a half of the length of the mold in the conveying direction is provided between the tables for different process steps. The mold 5 is conveyed between the tables 6 as it is lifted up from the tables 6 at a time of conveying the mold 6.

### CROSS REFERENCE TO RELATED APPLICATIONS

This application is a continuation application of PCT/JP06/317577, filed Sep. 5, 2006, which claims benefit of and priority to Japanese Patent Application No. 2005-257843 filed on Sep. 6, 2005, the entire contents of each of which are incorporated herein by reference.

### TECHNICAL FIELD

The present invention relates to a molding apparatus for press-molding optical elements such as high-precision glass lenses to be used for optical instruments.

### BACKGROUND ART

Heretofore, molding apparatuses have been used for producing a glass lens by press-molding a heated and softened glass molding material by pressurizing the material. Since these apparatuses can omit e.g. a polishing step, they are recently widely used as production apparatuses capable of performing mass production.

Production method of glass lenses using such a production apparatus, is as follows. For example, a glass molding material preformed to have a ball shape is set in a mold constituted by a top mold, a bottom mold and a body mold, the glass molding material is heated to about 500° C. to be softened in a heating step, pressurized to be molded into a lens product, cooled and retrieved as a product. Each of these steps are carried out in a chamber which is filled with non-oxidative atmosphere in which no oxygen enters, to prevent oxidation of, in particular, heated molds. A glass molding material in a mold is sequentially conveyed to heating, press-molding and cooling step zones arranged on a linear or a circular conveying path.

In such a molding apparatus, heretofore, the following means have been employed for conveying molds to carry out these steps.

For example, an apparatus disclosed in Patent Document 1 employs comb-shaped poles to push molds forward, and an apparatus disclosed in Patent Document 2 employs a pole provided with a rotational pushing arm to push molds to convey the molds. Each of these conveying means conveys molds by sliding the molds on tables. Accordingly, each of these conveying means has a merit that heat conduction to a mold is possible while the mold is conveyed in a case where the table in each step for placing the mold is provided with a heating or cooling function.

However, it is not possible to convey the molds by sliding the molds if there is a large gap or a height difference between the tables. If the tables are closely arranged to each other to cope with this problem, each table becomes susceptible to thermal influence of adjacent process steps, and there occurs a problem that molding accuracy is deteriorated.

Namely, each of the conventional methods is a method of conveying a mold between tables by sliding the mold in a state that the mold is in contact with an upper surface of the tables (in a state that the weight of the mold is supported by the tables). However, there is a case where a gap is required between the tables by separating a conveying path, for e.g. thermal insulation between process step zones. In such a case, at a time of using a conventional conveying method of sliding a mold on tables, the gap has to be as small as possible and at most a half of the length of the mold in a conveying direction in order to make the moving mold smoothly pass through the gap without being fallen into the gap from the end of a table. If the gap is larger, the mold inclines by its own weight, and thus, can not be conveyed to an adjacent table. Accordingly, it is not possible to obtain sufficient effect of reducing thermal influence between the tables by the method of separating the tables from each other.

Further, by a friction at the time of sliding, the molds or the tables are worn in a short time, which deteriorates molding accuracy.

Accordingly, the molds or the tables are frequently replaced, which increases a cost.

Further, since a mold is conveyed by employing a pole, a shock is applied to a mold in a horizontal direction when the pole contacts the mold, whereby a glass molding material tends to shift from a predetermined position in the mold. If the position of the molding material is shifted, thickness of a molded lens becomes asymmetric and molding accuracy is deteriorated.

Furthermore, if the number of molds conveyed at the same time increases, operation stroke of the pole increases, which makes entire apparatus large sized and increases required rigidity of the pole to obtain accurate positioning. Furthermore, when e.g. the number, arrangement or dimensions of molds conveyed at the same time, is changed, entire conveying mechanism needs to be rebuilt.

Patent Document 3 discloses an apparatus which employs a conveying jig having concave portions for positioning molds, and conveys a plurality of molds fitted in the concave portions, so that the molds are conveyed to the respective correct positions in a case where a plurality of molds are conveyed at the same time.

However, since the molds thermally expand when they are heated, it is necessary to accurately unify the thermally expanded outer dimensions of the molds, in order to position the molds by fitting the outer face of the molds to the concave portions, and thus, strict dimension control is required.

Further, in a case where the conveying jig for positioning molds is always contacts the molds, both of the molds and the conveying jig become heated (or cooled) objects in the heating or the cooling step, which increases total heat capacity and requires unnecessary heating and cooling to consume unnecessary amount of heat.

Meanwhile, in order to solve the above-mentioned problem of sliding, it is effective to convey a mold as it is lifted. In order to convey the mold as it is lifted, it is necessary to scoop up the mold from lower side or lift up the mold by catching e.g. a flange of the mold. For example, Patent Document 4 discloses a mold having a structure that a top mold and a bottom mold each has a flange portion and inside of a body mold has a step to support the top mold and the bottom mold. In the case of such a mold having a body mold accommodating the top mold and the bottom mold, it is not possible to lift up the mold by supporting the body mold since the bottom mold falls down.

Further, in order to mold a precision product by placing a molding material at the center in a mold, it is necessary to accurately align the position of the axis of a bottom mold of the mold. When the mold is lifted up to be conveyed, it becomes necessary to position the mold again after it is conveyed, which requires an apparatus for positioning the mold, which increases a cost and requires extra time to deteriorate productivity.

Patent Document 5 discloses a method of positioning a mold at a time of conveying the mold as it is lifted up. According to the method, a recess having a guide portion for positioning a body mold, is provided in a table to place a lifted-up mold. However, since the temperature of a mold before the molding step is lower than the temperature at the time of heating, there is a gap between a body mold and top and bottom molds in the mold before the molding step. Accordingly, even if the position of outer periphery of the body mold is positioned, center positions of the top mold and the bottom mold are not always aligned, and thus, molding precision is not sufficient.

Patent Document 1: JP-B-8-13687

Patent Document 2: JP-B-3-55417

Patent Document 3: Japanese Patent No. 2785683

Patent Document 4: Japanese Patent No. 3134581

Patent Document 5: JP-A-2002-255573

### DISCLOSURE OF THE INVENTION

### Problems to be Solved by the Invention

The present invention has been made considering the above-mentioned prior arts, and it is an object of the present invention to provide a molding apparatus of optical elements, which has a simple structure and performs simple process steps, which reduces thermal influence received from adjacent process steps, and which can carry out molding of precision optical elements.

### Means for Solving the Problems

The invention of Claim 1 provides an apparatus for molding optical elements, which comprises a conveying path having a plurality of tables continuously arranged to circulate a mold constituted by a top mold, a bottom mold and a body mold, and which applies heating, press-molding and cooling steps to the mold placed on the tables during the circulation, wherein a gap of at least about a half of the length of the mold in the conveying direction is provided between the tables for different process steps.

The invention of Claim 2 provides an apparatus for molding optical elements, which comprises a conveying path having a plurality of tables continuously arranged to circulate a mold constituted by a top mold, a bottom mold and a body mold, and which applies heating, press-molding and cooling steps to the mold placed on the tables during the circulation, wherein the mold is conveyed between the tables as the mold is lifted up from the tables at a time of conveying the mold.

The invention of Claim 3 is, in the invention of Claim 2, characterized by comprising a conveying jig for lifting up the mold from the table without restricting the mold in the horizontal direction, by supporting the mold while keeping a predetermined gap in a horizontal direction, at the time of conveying the mold.

The invention of Claim 4 is, in the invention of Claim 3, characterized in that the predetermined gap is a gap sufficiently larger than heat expansion and shrinkage amounts of the mold.

The invention of Claim 5 is, in the invention of Claim 3 or 4, characterized in that the predetermined gap is a gap sufficiently larger than the variation of external dimension of the mold.

The invention of Claim 6 is, in the invention of Claim 3, 4 or 5, characterized in that the conveying jig is isolated from the mold when the mold is placed on the table.

The invention of Claim 7 is, in the invention of any one of Claims 2 to 6, characterized in that one of the bottom mold and the table is provided with a convex portion, the other one of them is provided with a concave portion, the convex portion and the concave portion are fittable to each other to form positioning means, and at least one of the convex portion and the concave portion is provided with a taper-shaped guide surface.

The invention of Claim 8 is, in the invention of any one of Claims 2 to 7, characterized in that a flange or a step is provided on the outer periphery of the body mold, and the mold is lifted up by the conveying jig by contacting the conveying jig to a lower surface side of the flange or the step.

The invention of Claim 9 is, in the invention of any one of Claims 2 to 8, characterized in that an engage portion is formed so as to project from an inner surface of the body mold, to hold the bottom mold at the time of conveying the mold.

### EFFECTS OF THE INVENTION

According to the invention of Claim 1, by providing a gap of at least about a half of the length of a mold in the conveying direction between tables of different process steps, sufficient heat insulation effect is obtained by the gap, and it is possible to prevent adjacent tables from providing thermal influence to each other. Accordingly, temperature slope is not formed in a mold, and uniform temperature distribution is maintained in each table, whereby a high-precision press-molded product is obtained. In this construction, a mold is conveyed without using a conventional method of sliding the mold, and the mold is conveyed as its weight is supported by a tool other than the tables, whereby the mold can be smoothly conveyed over a gap between tables without being dropped into the gap.

According to the invention of Claim 2, by conveying a mold as it is lifted up, the mold can be smoothly conveyed even if there is a large gap between tables of different process steps, or even if there is a height difference in a vertical direction between surfaces of the tables. Accordingly, it becomes possible to provide a gap for heat insulation between tables of different process steps, or to dispose e.g. a heat-insulation partition member, whereby it is possible to prevent thermal influence between process steps to obtain a high precision molded product.

Further, by conveying the mold as it is lifted up from a table, surfaces of the mold and the table become to be scarcely worn, whereby there is no need of employing expensive abrasion resistance materials, and there is less need of replacing the mold or the table due to wearing, and production cost can be reduced.

According to the invention of Claim 3, since the conveying jig supports a mold with a predetermined gap in a horizontal direction, the conveying jig does not apply a shock in the horizontal direction to the mold. Accordingly, a molding material for an optical element does not shift in the mold, and molding precision is not deteriorated. Further, even if there is a variation of outer dimensions of molds, the conveying jig can securely support the molds and convey the molds. Moreover, since the molds are lifted up by the conveying jig, even if e.g. the number, the arrangement or the dimension of molds to be set in the conveying jig, is changed, it is only necessary to replace the conveying jig, and the conveying mechanism can be continuously used. Accordingly, there is no need of redesigning and rebuilding of the conveying mechanism, and thus, the conveying mechanism is excellent in general-purpose use capability.

According to the invention of Claim 4, since the gap in a horizontal direction between the conveying jig and a mold, is larger than thermal expansion amount of the mold, even if expansion or shrinkage occurs by heating or cooling of the mold, it is possible to smoothly convey the mold without being affected by the dimension change.

According to the invention of Claim 5, since a gap in a horizontal direction between the conveying jig and a mold, is larger than variation of external dimension of the mold, even if there occurs an external dimension error, it is possible to smoothly convey the mold without being affected by the dimension error of each mold. Accordingly, it is possible to reduce a work load for controlling external dimensions of molds, and to reduce the cost.

According to the invention of Claim 6, when a mold is placed on a table and subjected to a process step of heating or cooling, the conveying jig is isolated from the mold, heat is not conducted between the mold and the conveying jig, whereby heat capacity does not unnecessarily increase and a heat source and production time can be saved.

According to the invention of Claim 7, by providing each of a bottom mold and a table with a guiding surface having a taper, the bottom mold is automatically placed at a correct position when a mold conveyed as it is lifted up is placed on the table. Namely, even without strictly controlling the conveying mechanism, it is possible to place a mold accurately at a predetermined position using a simple structure. Accordingly, there is no need of providing e.g. an apparatus for positioning the mold, cost and the time can be saved, and accordingly, productivity is increased. In this case, since the object aligned to the table is not a body mold but a bottom mold on which a glass molding material is placed, it is possible to achieve high-precision positioning of the glass molding material.

According to the invention of Claim 8, by contacting a conveying jig to a flange provided on the periphery of a body mold or a lower surface of a step of the body mold, it is possible to easily lift up the mold. Moreover, since the mold is lifted up without restricting the position of the mold in a horizontal direction, the conveying jig does not apply a shock in the horizontal direction to the mold, whereby a molding material does not shift in the mold.

According to the invention of Claim 9, since an engage portion is formed in an inner surface of a body mold for holding a bottom mold, it is possible to easily lift up entire mold without dropping the bottom mold out of the body mold when the body mold is lifted up.

### BRIEF DESCRIPTION OF DRAWINGS

FIG. 1: A plan view showing a molding apparatus for optical elements according to the present invention.

FIG. 2: A front view of FIG. 1.

FIG. 3: A perspective view showing a conveying path portion of FIG. 2.

FIGS. 4(A) to 4(C): Front views showing a conveying sequence according to the present invention.

FIGS. 5(A) to 5(C): Front views showing a conveying sequence subsequent to FIGS. 4(A) to 4(C).

FIGS. 6(A) and 6(B): Side views of conveyance according to the present invention.

FIGS. 7(A) to 7(C): Enlarged cross-sectional views of a mold and its vicinity in the conveyance according to the present invention.

FIGS. 8(A) and 8(B): Cross-sectional views showing other examples of a convex portion and a concave portion for positioning a mold.

FIG. 9: A cross-sectional view showing another example of mold.

FIGS. 10(A) to 10(C): Front views showing another example of conveying mechanism of the present invention.

FIGS. 11(A) to 11(C): Explanation views of other examples of the present invention.

### EXPLANATION OF NUMERALS

1: molding apparatus, 2: conveying path, 3: molding material, 4: product, 5, 5a, 5b, 5c, 5d: mold, 6: table, 7, 7a: conveying mechanism, 10: chamber, 11: molding material supply zone, 12: heating zone, 13: molding zone, 14: cooling zone, 15: product retrieving zone, 16: heat insulation member, 17: heating step cylinder, 19: molding step cylinder, 18: cooing step cylinder, 20: conveying jig, 20a: catching hole, 21: heat insulation cover, 22: heating plate, 23: molding plate, 24: cooling plate, 25: jig-rest, 31: molding material tray, 32: molding material supply robot, 41: product tray, 42: product retrieving robot, 51: top mold, 52, 52a, 52b: bottom mold, 53: body mold, 54: step portion, 55, 55a, 55b: concave portion, 56: flange, 57: engage portion, 58: lower surface, 61, 61a, 61b: convex portion, 71: arm, 72: horizontal cylinder, 73: vertical cylinder, 74: parallel crank mechanism, 75: crank arm, 76: flange, 77: first body mold, 78: second body mold.

### BEST MODE FOR CARRYING OUT THE INVENTION

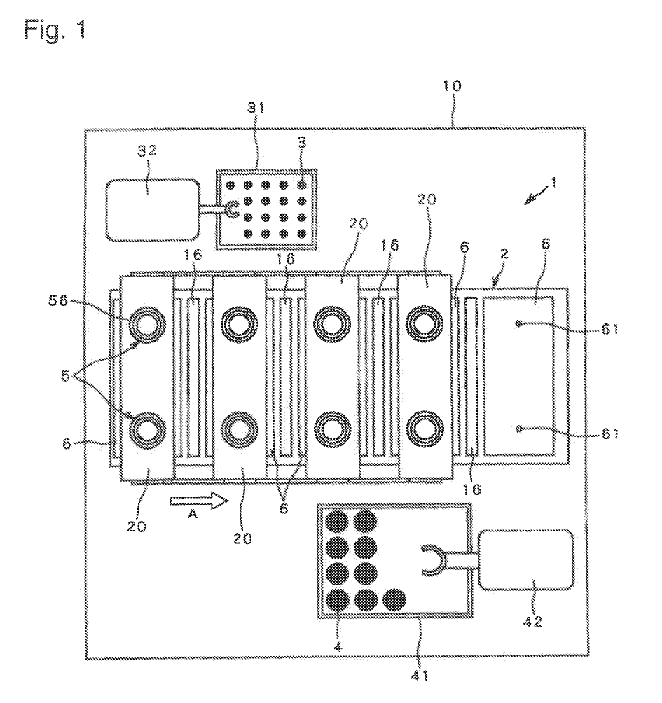

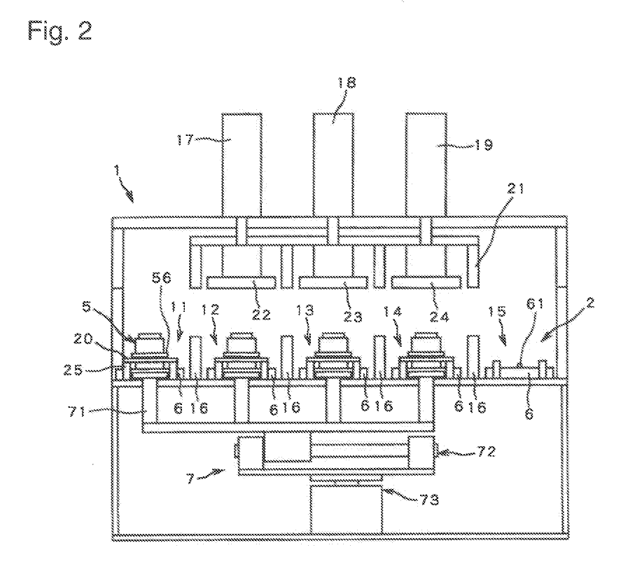

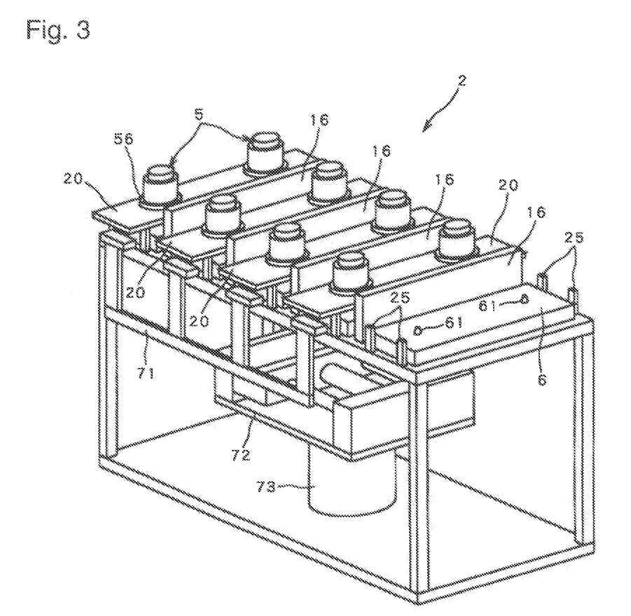

FIGS. 1 to 3 show an example of the present invention. FIG. 1 is a plan view, FIG. 2 is a front view and FIG. 3 is a perspective view.

FIG. 1 is a plan view of entire apparatus. A molding apparatus 1 is accommodated in an air-tight chamber 10, and the chamber 10 is filled with a non-oxidative atmosphere, for example, nitrogen atmosphere.

A conveying path 2 of linear shape is provided in the chamber 2 to convey a mold 5 in a direction of an arrow A from left to right in the figure. Adjacently to the conveying path 2, a molding material tray 31 for accommodating molding materials 3 being glass balls, and a product tray 41 in which press-molded products 4 being molded optical elements, are disposed, and in the vicinity of the trays 31 and 41, robots 32 and 42 are disposed to convey the molding materials 3 and the products 4 respectively. Replacement of the molding material tray 31 and the product tray 41 are carried out through an in-out port, not shown, of the chamber 10 as the port is opened and closed, and at this time, nitrogen gas is supplied to the chamber 10 so as to increase the gas pressure to prevent air from entering into the chamber 10.

In this example, as shown in FIG. 1, two molds constitutes one group and occupies one section, and the molds are placed on a table 6 provided for each section. Namely, a group (2 pieces) of molds are pressurized at the same time, and two molded products are obtained by press-molding at the same time. On the table 6, convex portions 61 are formed to determine the positions of the molds 5.

FIG. 2 is a front view of the conveying path 2 portion of FIG. 1. In FIG. 2, a raw material supply zone 11, a heating zone 12, a molding zone 13, a cooling zone 14 and a product retrieving zone 15 are formed in the respective sections from the left side. Between tables 6 of adjacent sections, a heat insulation member 16 is disposed.

Above the heating zone 12, the molding zone 13 and the cooling zone 14, a heating step cylinder 17, a molding step cylinder 18 and a cooling step cylinder 19 are provided so as to be movable up and down to operate for the respective process steps. At leading edges of the cylinders 17, 18 and 19, a heating plate 22, a molding plate 23 and a cooling plate 24 are attached respectively, and the plates 22, 23 and 24 are partitioned from each other by a heat insulation cover 21 to prevent mutual thermal influence. When the heating step cylinder 17, the molding step cylinder 18 or the cooling step cylinder 19 moves down, the lower ends of the heat insulation cover 21 contact to the upper ends of the heat insulation members 16 to form heat insulation walls so that each process step receives no thermal influence from adjacent other process steps. Here, in a case where the influence of radiation heat is small, it is enough to provide between adjacent tables 6 low heat insulation members 16 not protruding highly from the surface of the tables 6.

In this example, between adjacent tables 6, a gap is provided, and the gap is at least a half of the length of the mold in the conveying direction. By providing such a wide gap, sufficiently large heat insulation effect can be obtained. Accordingly, the heat insulation members 16 in gaps between the tables may be omitted depending on e.g. temperature conditions. However, in order to increase heat insulation effect, it is preferred to provide the heat insulation members 16 in the gaps.

Provision of such a wide gap enough to obtain sufficiently large heat insulation effect between the tables 6, is possible in the present invention in which a mold is carried as it is lifted up from the tables 6.

Under the conveying path 2, a conveying mechanism 7 is provided. The conveying mechanism 7 is constituted by arms 71 for supporting conveying jigs 20, and air cylinders 72 and 73 of horizontal and vertical directions respectively. The arms 71 are fixed to the horizontal cylinder 72 and move in a horizontal direction according to movement of the horizontal cylinder 72, and the horizontal cylinder 72 is attached to the leading edge of the vertical cylinder 73 and moves in a vertical direction according to the movement of the vertical cylinder 73.

FIG. 3 is a perspective view of the conveying path 2. Each of the conveying jigs 20 conveys, as shown in the figure, molds 5 by lifting up a flange 56 of each mold from its lower surface side, and the conveying jig 20 is placed on a jig-rest 25 provided in each section of the conveying path 2 and isolated from molds 5 when the jig is not conveying the molds. At a time of conveying molds, the vertical cylinder 73 moves up, whereby the arm 71 moves up to lift up the conveying jigs 20 from its lower surface side, and the conveying jig 20 lifts up the molds 5.

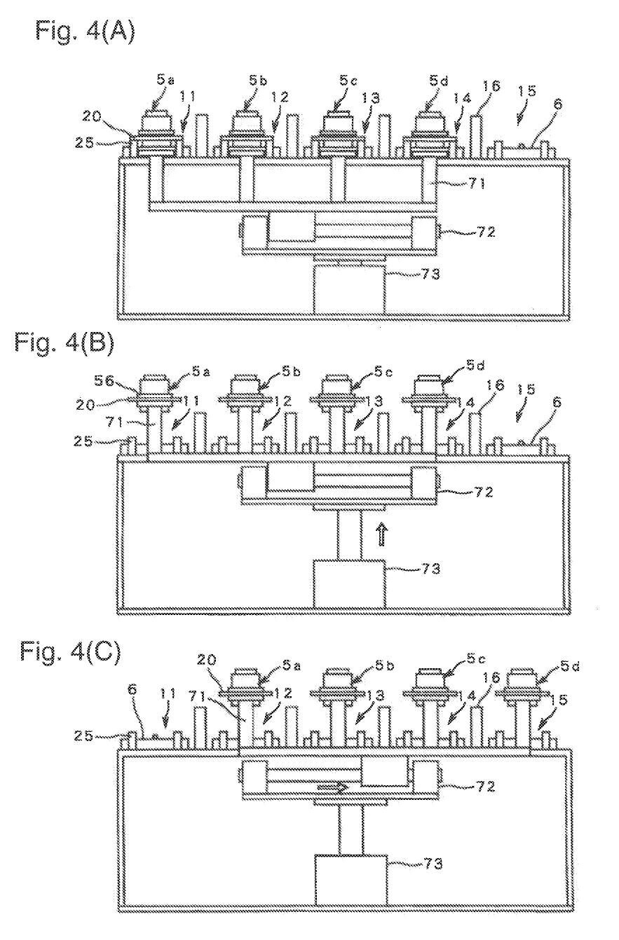

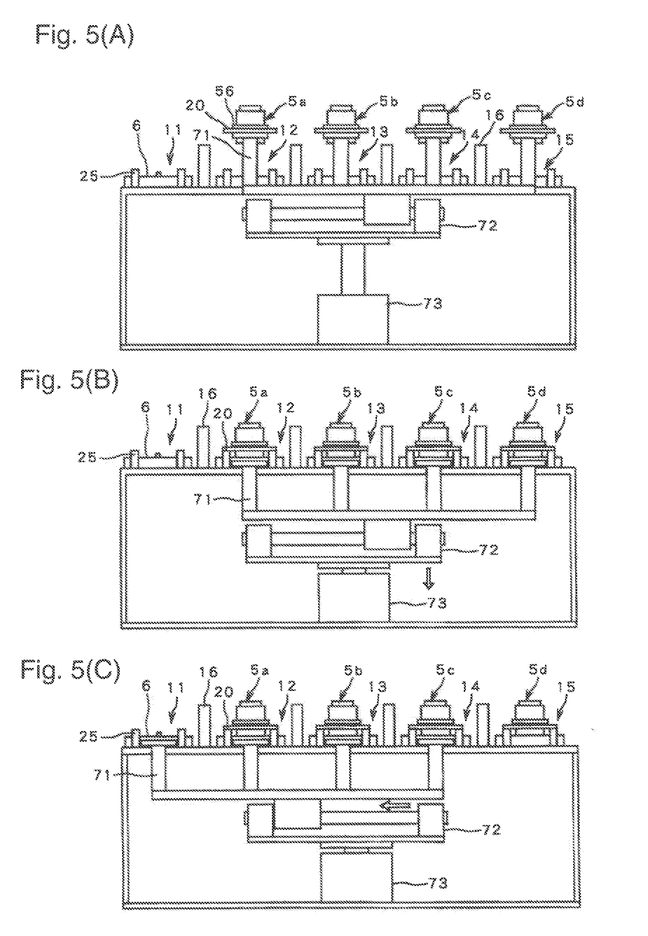

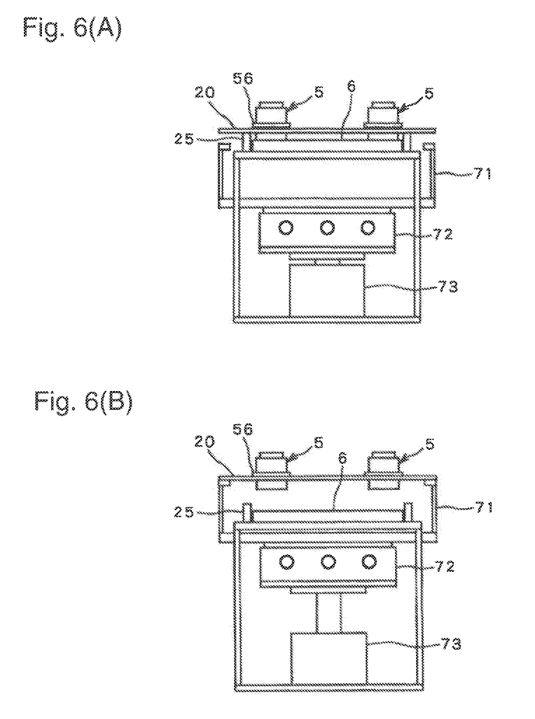

FIGS. 4 to 6 are explanation views showing a state that molds are conveyed. FIGS. 4(A) to 4(C) show a step of lifting molds and conveying them to adjacent sections, FIGS. 5(A) to 5(C) are front views showing a step of moving down the conveyed molds, and FIGS. 6(A) and 6(B) are side views showing a state that molds 5 are placed on a table 6 and a state that the molds 5 are lifted up.

FIG. 4(A) shows a state that molds 5a, 5b, 5c and 5d are respectively placed in a molding material supply zone 11, a heating zone 12, a molding zone 13 and a cooling zone 14, that are positioned in this order from left side. At this time, as shown in FIG. 6(A), a conveying jig 20 is placed on a jig-rest 25, and thus, does not contact the molds 5. Namely, the conveying jig 20 is isolated from a lower surface of a flange 56 in the periphery of each of the molds 5. At this position, in the mold 5a in the raw material supply zone 11, a molding material being a glass ball is set on a bottom mold, and a top mold is fitted on the bottom mold. To the mold 5b in the heating zone 12, a heating step is applied to heat the mold 5b to a temperature at which the molding material becomes soft enough to be moldable by pressurizing. To the mold 5c in the molding zone 13, a molding step is applied to press-mold the molding material to obtain a product of predetermined dimension. To the mold 5d in the cooling zone 14, a cooling step is applied to cool the mold to a suitable temperature at which the quality of the product becomes stable.

When these steps are completed, as shown in FIG. 4(B), the horizontal cylinder 72 and the arm 71 is moved up by the vertical cylinder 73, so that, as shown in FIG. 6(B), the molds 5a, 5b, 5c and 5d are lifted up as the respective flanges 56 are supported by the conveying jigs 20 pushed up by the arm 71.

From the state of FIG. 4(B), the arm 71 is moved to is right direction by the horizontal cylinder 72 so that, as shown in FIG. 4(C), the molds 5a, 5b, 5c and 5d move to the respective adjacent sections.

FIG. 5(A) shows the same state as FIG. 4(C), wherein the molds 5a, 5b, 5c and 5d are disposed above the heating zone 12, the molding zone 13, the cooling zone 14 and the product retrieving zone 19 respectively.

From the position of FIG. 5(A), the horizontal cylinder 72 and the arm 71 are moved down by the vertical cylinder 73 so that, as shown in FIG. 5(B), the conveying jigs 20 are placed on the jig-rests 25. Accordingly, the molds 5a, 5b, 5c and 5d are placed on the respective tables 6. At this position, heating step is applied to the mold 5a in the heating zone 12, molding step is applied to the mold 5b in the molding zone 13, cooling step is applied to the mold 5c in the cooling zone 14, and from the mold 5d in the product retrieving zone 15, a top mold is removed to take out a product completed by completing the series of process steps.

Thereafter, the arm 71 is moved in the left direction by the horizontal cylinder 72 so that, as shown in FIG. 5(C), the arm 71 returns to the original position. Then, by a conveying mechanism, not shown, the mold 5d is conveyed from the product retrieving zone 15 to the raw material supply zone 11. Thus, production steps of FIGS. 4(A) to 4(C) and FIGS. 5(A) to 5(C) are repeated.

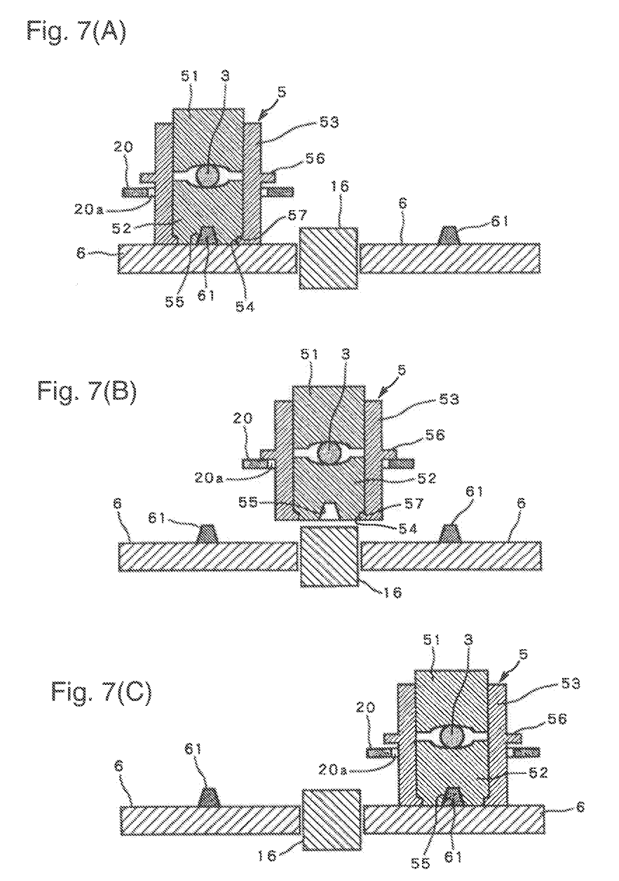

FIGS. 7(A) to 7(C) are enlarged cross-sectional views showing the state of a mold 5 being conveyed. FIG. 7(A) shows a state before the conveyance, wherein the mold 5 is placed on a table 6 of one of the tables partitioned by a heat insulating member 16. FIG. 7(B) shows a state during the conveyance, wherein the mold 5 moves over the heat insulation member 16 as it is lifted up by a conveying jig 20. FIG. 7(C) shows a state after the conveyance, wherein the mold 5 is placed on the adjacent table 6.

The mold 5 is constituted by a tube-shaped body mold 53, a bottom mold 52 to be fit into the body mold 53, and a top mold 51 slidable in the body mold 53. A lower surface of the top mold 51 and an upper surface of the bottom mold 52 are molding surfaces, and a molding material 3 is disposed between these surfaces and pressed to be an optical element. On the outer periphery of the body mold 53, a flange 56 is formed. At a lower end of the body mold 53, an engage portion 57 is formed to protrude inwardly, so that the step portion 54 formed at the lower end of the bottom mold 52 and the engage portion 53 are engaged with each other, whereby when the body mold 53 is lifted up by the conveying jig 20, the bottom mold 52 is held without slipping down and lifted up together with the body mold 53. Further, at the center of the lower surface of the bottom mold 52, a concave portion 55 is formed to position the body mold on the table 6. The concave portion 55 fits with a convex portion 51 provided on the table 6 for positioning. In order to make the concave portion 55 securely fit with the convex portion 61 even if there occurs a shift at a time of conveying, the convex portion 61 has a taper so that the diameter of the convex portion 61 increases from top side toward bottom side, whereby the bottom mold 52 is fit by being guided by the taper. Accordingly, the bottom mold is placed to an accurate position so that its axis is aligned.

Thus, by accurately aligning the position and the axis of the bottom mold 52, press is carried out in a state that a molding material 3 is disposed at a correct position in the mold 5, whereby a precision product is formed.

Further, the conveying jigs 20 are each provided with catching holes 20a each having a diameter larger than thermally expanded outer diameter of a body mold of a mold 5 originally having the largest dimension within a production variation range and being thermally expanded by heating whereby the mold 5 can be conveyed without being restricted in the horizontal direction.

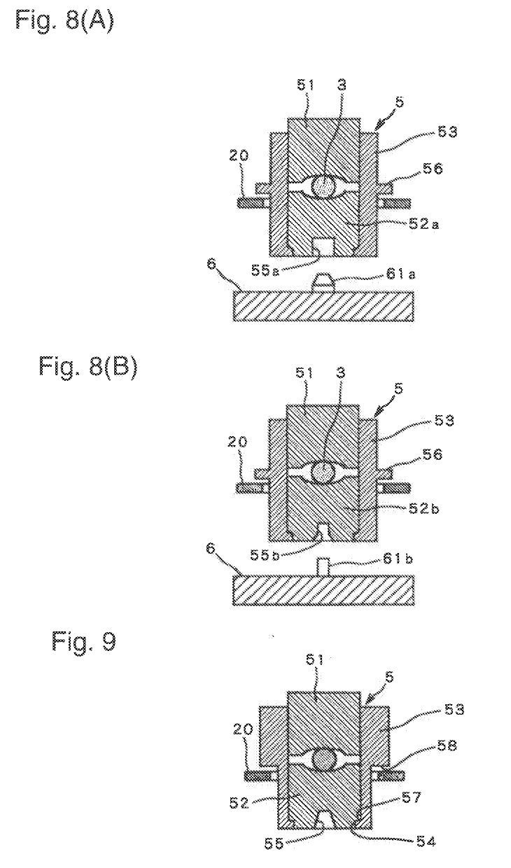

FIG. 8 shows another example of convex portion for positioning. In order to accurately fit the convex portion into a concave portion of the bottom mold even if the position of the bottom mold is slightly shifted at a time of conveying, it is sufficient that a taper is formed either at an entrance of the concave portion formed in the bottom mold or at the leading edge of the convex portion formed on the table 6. FIG. 8(A) shows an example that a taper is formed at the leading edge of the convex portion 61a, in which the lower portion of the convex portion 61a and the concave portion 55a of the bottom mold 52a are configured to be fit together as they are guided by the taper. FIG. 8(B) shows an example that a taper is formed at the entrance side at the lower end of the concave portion 55b of the bottom mold 52b, in which the deep portion of the concave portion 55b and the convex portion 61b are configured to be fit together after they are guided by the taper.

FIG. 9 shows another example of body mold. Instead of the flange 56 of the body mold 53 of FIG. 7, a step is provided so that the diameter of upper portion becomes larger than the diameter of the lower portion. Also in this case, by contacting a conveying jig 20 to a lower surface 58 of the step, the conveying jig 20 can lift up the mold in the same manner as the case of body mold having a flange.

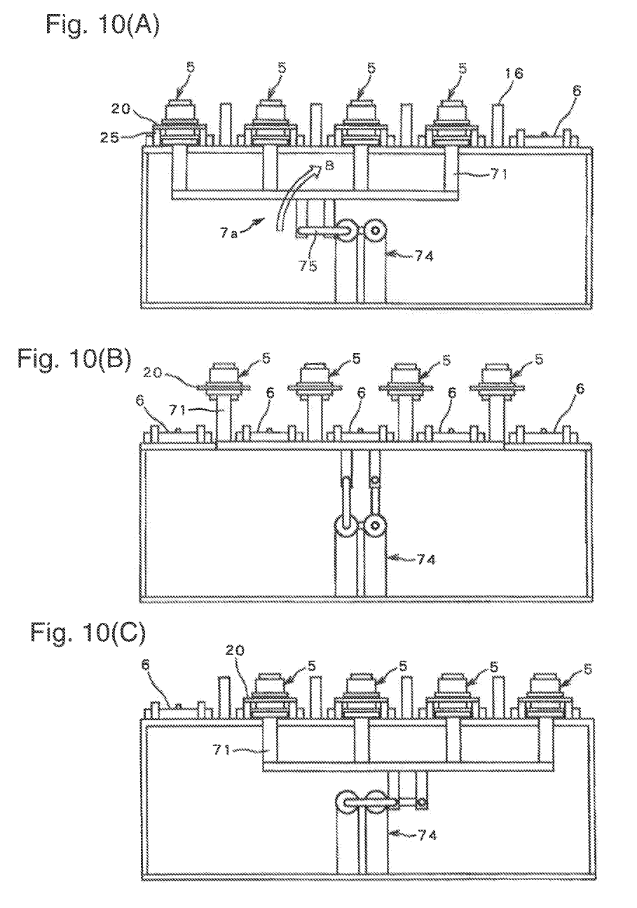

FIGS. 10(A) to 10(C) show another example of conveying mechanism, and show a conveying mechanism 7a employing a parallel crank mechanism 74 instead of the air cylinders of the conveying mechanism 7 shown in FIGS. 4 to 6. To an arm 71 on each side of the conveying path, a crank arm 75 is connected. From the state of FIG. 10(A), by rotating the crank arm 75 as shown in an arrow B, the arm 71 is moved upwardly to lift up the molds 5 using the conveying jigs 20. As shown in FIG. 10(B), the molds 5 are lifted up to the highest position at intermediate positions between the tables. Thereafter, the crank arm 75 is further rotated to move down the arm 71 and moves it to right direction so that, as shown in FIG. 10(C), the conveying jigs 20 are placed on jig-rests 25 and the molds 5 are placed on predetermined positions of respective tables at positions one section distant in the right direction from original positions. Thus, in the same manner as FIGS. 4 and 5, it is possible to convey the molds 5 as they are lifted up by the conveying jigs 20.

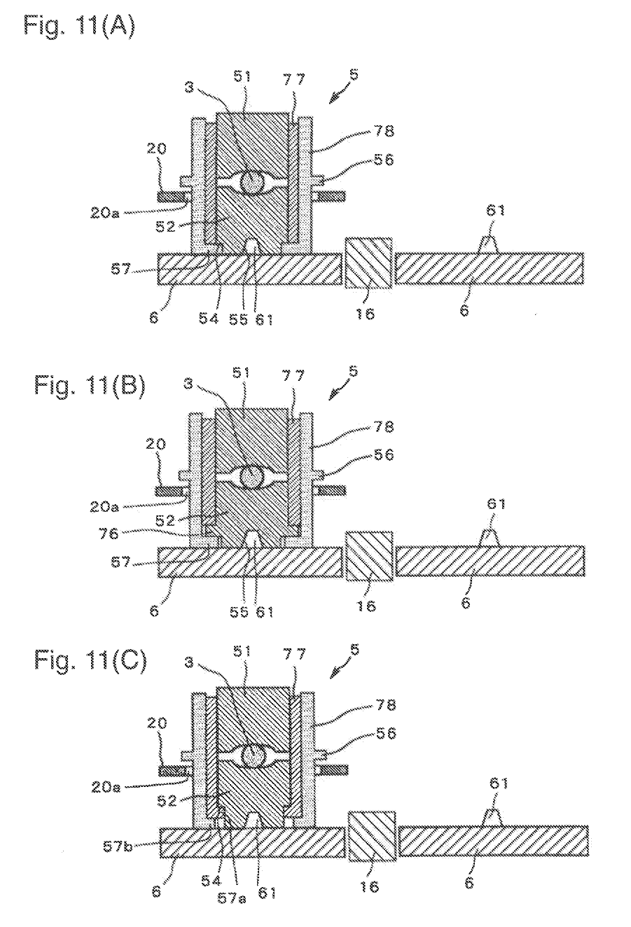

FIGS. 11(A) to 11(C) show other examples of the present invention. In each of these examples, a body mold has a double structure so that the positioning of a molding plate 23 in the height direction can be easily and securely carried out at a time of press-molding using the molding plate 23 (FIG. 2).

The molds 5 of FIGS. 11(A) to 11(C) each has a construction that it has a first body mold 77 and a second body mold 78, a top mold 51 and a bottom mold 52 are fit into the first body mold 77, and the first body mold 77 is fit into the second body mold 78. In each example, an upper end surface of the second body mold 78 slightly projects from an upper end surface of the first body mold 77. When a molding plate 23 (FIG. 2) moves down to press the top mold 51 to mold a molding material 3 present between the top mold 51 and the bottom mold 52 at a time of press molding, the second body mold 78 functions as a stopper to restrict the press position. Accordingly, by forming the height of the second body mold 78 to be a predetermined height, it is possible to position the molding plate, whereby it is possible to easily obtain a press-molding product having a predetermined thickness with high precision.

In the example of FIG. 11(A), a step portion 54 is formed on an outer periphery of lower end of the bottom mold 52, and an engage portion 57 is formed to protrude from an inner face of lower end of the second body mold 78 so that the engage portion 57 engages with the step portion 54 from the bottom to hold the bottom mold 52. By the engage portion 57, it is possible to prevent dropout of the top and bottom molds 51 and 52 and the first body mold 77 when the mold is conveyed as it is lifted up.

In the example of FIG. 11(B), a flange 76 is formed to protrude from an outer periphery of lower portion of the bottom mold 52, and in the same manner as FIG. 11(A), the engage portion 57 of the second body mold 78 supports the flange 76 from the bottom to prevent dropout at a time of conveying a mold.

In the example of FIG. 11(C), a step portion 54 of the outer periphery of lower end of the bottom mold 52 is held by an engage portion 57a formed in a first body mold 77, and the first body mold 77 is held by the engage portion 57b of a second body mold 78. Also by such a construction, dropout at a time of conveying a mold can be prevented.

Here, each of the above examples shows a case where each section is occupied by two molds arranged in parallel in two rows in a conveying direction, but the present invention can be easily applied to a case where three or more molds arranged in three or more rows occupy each section or a case where a plurality of molds arranged in a conveying direction occupy each section, only by changing the shape of the conveying jig 20. Further, each of the above examples show a molding apparatus having a linear conveying path 2 and having sections for respective process steps. However, the present invention can be carried out in an embodiment different from the above examples such as an embodiment of an apparatus having a conveying path constituted by an outgoing path and a returning path.

### INDUSTRIAL APPLICABILITY

The present invention can be applied to an apparatus for producing molded products, which carries out process steps of heating, molding and cooling.

What is claimed is:

1. An apparatus for molding optical elements, which comprises a conveying path having a plurality of tables continuously arranged to circulate a mold constituted by a top mold, a bottom mold and a body mold, and which applies heating, press-molding and cooling steps to the mold placed on the tables during the circulation, wherein a gap of at least about a half of the length of the mold in the conveying direction is provided between the tables for different process steps.

2. An apparatus for molding optical elements, which comprises a conveying path having a plurality of tables continuously arranged to circulate a mold constituted by a top mold, a bottom mold and a body mold, and which applies heating, press-molding and cooling steps to the mold placed on the tables during the circulation, wherein the mold is conveyed between the tables as the mold is lifted up from the tables at a time of conveying the mold.

3. The apparatus for molding optical elements according to claim 2, which comprises a conveying jig for lifting up the mold from the table without restricting the mold in the horizontal direction, by supporting the mold while keeping a predetermined gap in a horizontal direction, at the time of conveying the mold.

4. The apparatus for molding optical elements according to claim 3, wherein the predetermined gap is a gap sufficiently larger than heat expansion and shrinkage amounts of the mold.

5. The apparatus for molding optical elements according to claim 3, wherein the predetermined gap is a gap sufficiently larger than the variation of external dimension of the mold.

6. The apparatus for molding optical elements according to claim 3, wherein the conveying jig is isolated from the mold when the mold is placed on the table.

7. The apparatus for molding optical elements according to claim 2, wherein one of the bottom mold and the table is provided with a convex portion, the other one of them is provided with a concave portion, the convex portion and the concave portion are fittable to each other to form positioning means, and at least one of the convex portion and the concave portion is provided with a taper-shaped guide surface.

8. The apparatus for molding optical elements according to claim 2, wherein a flange or a step is provided on the outer periphery of the body mold, and the mold is lifted up by the conveying jig by contacting the conveying jig to a lower surface side of the flange or the step.

9. The apparatus for molding optical elements according to claim 2, wherein an engage portion is formed so as to project from an inner surface of the body mold, to hold the bottom mold at the time of conveying the mold.
